(19) United States
(12) Patent Application Publication
(10) Pub. No.: US 2010/0271324 A1
(43) Pub. Date: Oct. 28, 2010

(54) Capacitive Touch Panel Label

(76) Inventor: Gregory Hayes, Aliso Viejo, CA (US)

Correspondence Address: FISH & ASSOCIATES, PC;ROBERT D. FISH, 2603 Main Street, Suite 1000, Irvine, CA, 92614-6232, US

(21) Appl. No.: 12/765,782

(22) Filed: Apr. 22, 2010

Related U.S. Application Data
(60) Provisional application No. 61/171,529, filed on Apr. 22, 2009.
(60) Provisional application No. 61/175,705, filed on May 5, 2009.

(51) Int. Cl. G06F 3/041

(52) U.S. Cl. 345/173

(57) ABSTRACT

A touch panel with both static elements is created by layering a glass cover over a label, which is then layered over a touch screen. The high quality label over the touch screen sets forth areas that could be used as buttons, switches, or potentiometers. The label could also have a die cut window that reveals a dynamic screen underneath, allowing for a touch screen with both static buttons that are always present and a dynamic interface that could react to user input.

This application claims priority to U.S. provisional applications having Ser. No. 61/175705 filed on May 5, 2009. This and all other extrinsic materials discussed herein are incorporated by reference in their entirety.

### FIELD OF THE INVENTION

The field of the intention is touch panel graphics.

### BACKGROUND

Touch-sensitive panels frequently have graphics that are integrated with the touch panel to provide a visual indication of the location of touch panel trigger locations. For example, U.S. Pat. No. 6,072,980 to Manico teaches a transparent touch-sensitive screen which is placed upon a label. A user would then look through the transparent touch-screen to determine where to touch the screen. Allowing a user to directly touch a transparent touch screen, however, reduces the life of the touch screen considerably.

Manico and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

U.S. Pat. No. 6,976,915 to Baker teaches a non-transparent touch panel with a cover lens that is etched with multiple layers of ink that create supplementary graphics over the touch panel to create a label over the touch panel. The supplementary graphics could show trigger locations that could be touched on the panel. Baker, however, requires multiple layers of silkscreen ink or paint to be used, and which is then protected by laminate, which requires a great deal of time and expense.

Thus, there is a need in the art for improved static graphics for touch panels.

### SUMMARY OF THE INVENTION

The present invention provides apparatus, systems and methods in which a printed label is placed between the surface of a touch screen and a cover in order to create a touch panel with labeling. This saves a considerable cost by avoiding the use of silk-screen cover lenses and creation of touch-sensitive screens.

The touch screen is generally planar and has a touch-sensitive side or screen that receives tactile input. The touch-sensitive side is generally designed to register the location on the panel that is touched by a user or an object. Many touch screens known in the art could be used, for example resistive touch screens composed of electrically conductive layers that register touch events that cause the layers to touch one another, strain gauge touch screens composed of strain gauges that measure the force of a person's touch against the gauges or acoustic touch screens composed of piezoelectric transducers that register the electric vibrations caused by a touch. Preferably, a projected capacitive touch (PCT) screen is used, which registers touch events of a conductive stylus or human appendage. This allows the cover to be rather stiff and hard to minimize damage suffered by the touch screen due to blunt force trauma. An exemplary embodiment of a PCT panel is an indium tin oxide (ITO) projected screen.

The label could comprise any suitable material, for example paper, PPC, Laser Film, or a thermoplastic like Mylar™. Generally, the label acts to compartmentalize segments of the touch screen into static buttons on the touch screen. While the label could be designed to mask the entire surface of the touch screen, preferably the label has one or more holes that reveal one or more dynamic screens, for example a plasma screen or an LCD screen. In this way, a user could have a touch screen with both static touch components for buttons that are always present, and dynamic touch components for a dynamic interface that reacts and changes depending on user input. As used herein, an element that “masks” a portion touch panel means to overlay such that an appendage may not directly touch the touch panel. In a preferred embodiment, light sources are placed underneath the portions of the label that designate static buttons so that the static buttons could be illuminated while the touch panel is in use.

In exemplary embodiments, the cover may only mask part of a touch screen, but in a preferred embodiment the cover masks the entire surface of the touch screen, or at least masks the entire surface of the touch-sensitive portion of the touch screen. The cover is preferably made of a completely transparent material, so that all light in the visible spectrum passes through the cover, but may be made of translucent or even opaque material, and may be tinted to give a translucent quality, without departing from the scope of the invention. Where the touch screen requires a compressive touch, such as in the case of a resistive touch screen or a piezoelectric touch screen, the cover is preferably made of a slightly elastic material to allow a compressive force to easily translate through the cover without breaking.

However, where the touch screen is a PCT panel, the cover is preferably made of a thin glass or lens that is less than 10 mm thick, more preferably less than 4 mm thick, and even more preferably less than 2 mm thick. The glass preferably has a high hardness ratio, for example 5 or 7 Moths hardness, to protect any components placed underneath the cover. While the cover is preferably flat, in some exemplary embodiments, a part of the cover could be curved to act as a magnification lens that will magnify sections of material placed underneath the lens.

In a preferred embodiment, the cover also has a bezel along the perimeter of the glass that that holds the cover against the touch panel. The bezel may have opaque, translucent, or transparent sections and parts, and preferably forms an airtight seal around the touch panel, for example by adhering directly to the touch panel or to a case that holds the touch panel in place. In an exemplary embodiment, the bezel forms a cavity that holds the touch screen and the label, such that a transparent curable resin could be used to hold all three components together before attaching the cover to a screen or a case. The bezel may be attached to a screen or a case in any suitable manner, for example using an adhesive or suction, but is preferably mechanically attached to allow for easy replacement of the entire cover, label, and touch screen when the touch screen is damaged.

### BRIEF DESCRIPTION OF THE DRAWINGS

FIG. 1 is front plan view of an embodiment of a touch screen of the present invention.

FIG. 2 is a front plan view of an embodiment of a label of the present invention.

FIG. 3 is a front plan view of an embodiment of a cover of the present invention.

FIG. 4 is a method of creating an embodiment of a touch panel of the present invention.

FIG. 5 is a side perspective view of the touch screen of FIG. 1, the label of FIG. 2, and the cover of FIG. 3 and a case holding an LCD screen.

FIG. 6 is a front perspective view of the case of FIG. 5 attached to the touch screen, label, and cover of FIG. 5.

### DETAILED DESCRIPTION

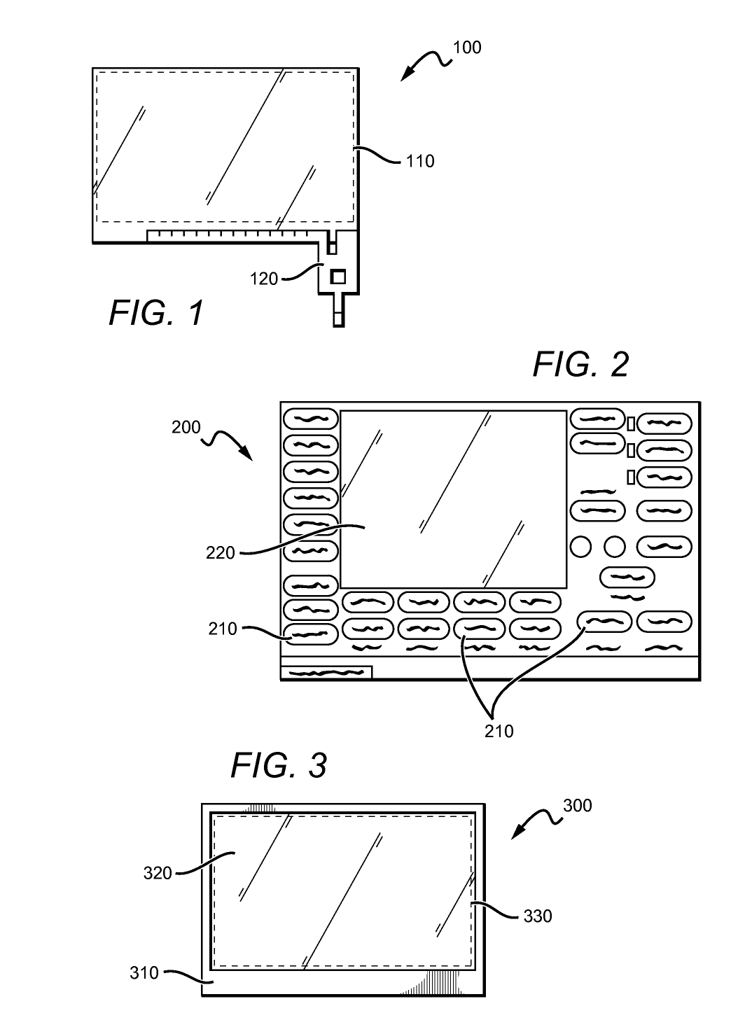

In FIG. 1, an exemplary touch screen 100 generally has touch-sensitive area 110 and electrical components 120 that register the location that a user touches the touch sensitive area 110. Touch screen 100 is preferably a PCT touch screen that is transparent or translucent that enables light from dynamic screens or backlights, for example LEDs, to penetrate through to the other side of the touch screen.

In FIG. 2, an exemplary label 200 generally has designated static touch-sensitive areas 210 and designated dynamic touch sensitive area 220. Dynamic touch-sensitive area 220 is simply a hole or a window in the label that enables light from dynamic screens to penetrate to the other side of label 200. The static touch-sensitive areas 210 could be completely opaque, but are preferably slightly translucent, especially around letters or symbols, to allow lights or LEDs from behind the label to illuminate buttons during dark conditions, or simply to improve legibility. Labels without die cut windows are contemplated to overlay touch screens that have no designated dynamic touch sensitive areas. Static touch-sensitive areas 210 could act as any kind of static touch-screen interface, for example a button or a potentiometer. As such, a user could push a labeled button, or slide a sliding or rotating potentiometer that has a static label.

Label 200 is preferably made of Mylar™, paper, or clear PPC/laser film and could be created using a standard printing technologies known in the art, for example laserjet, inkjet, or offset printers. This cuts down the cost of creating a label for a touch screen, which typically labels static touch-sensitive areas using industry standard silkscreens or glass inkjet printers, which are expensive processes. Printing technologies for paper are generally of higher quality than printing technologies for glass, which increases the resolution and general quality of the labels for the static portions of the touch screen. This also allows a user to rapidly print out many different labels to optimize sizing and usability constrains needed when prototyping many different designs.

In FIG. 3, an exemplary cover 300 generally has a transparent or a translucent screen 320 and bezel 310. Translucent screen 320 is typically a plain glass cover lens that overlays and protects the touch screen and the label, although other transparent or translucent materials could be used without departing from the scope of the current invention. Exemplary cover 300 has a slight cavity 330 sized and dimensioned to hold touch screen 100 and label 200. Preferably, an adhesive (not shown) is used while the touch screen and the label are sitting within cavity 330 to help in the curing process. In an exemplary embodiment, the adhesive is a curable resin, for example SVR1100 UV. Preferably, the glass cover is less than 5 mm, 4 mm, or 2 mm thick to allow a finger to register with a PCT screen placed underneath the cover.

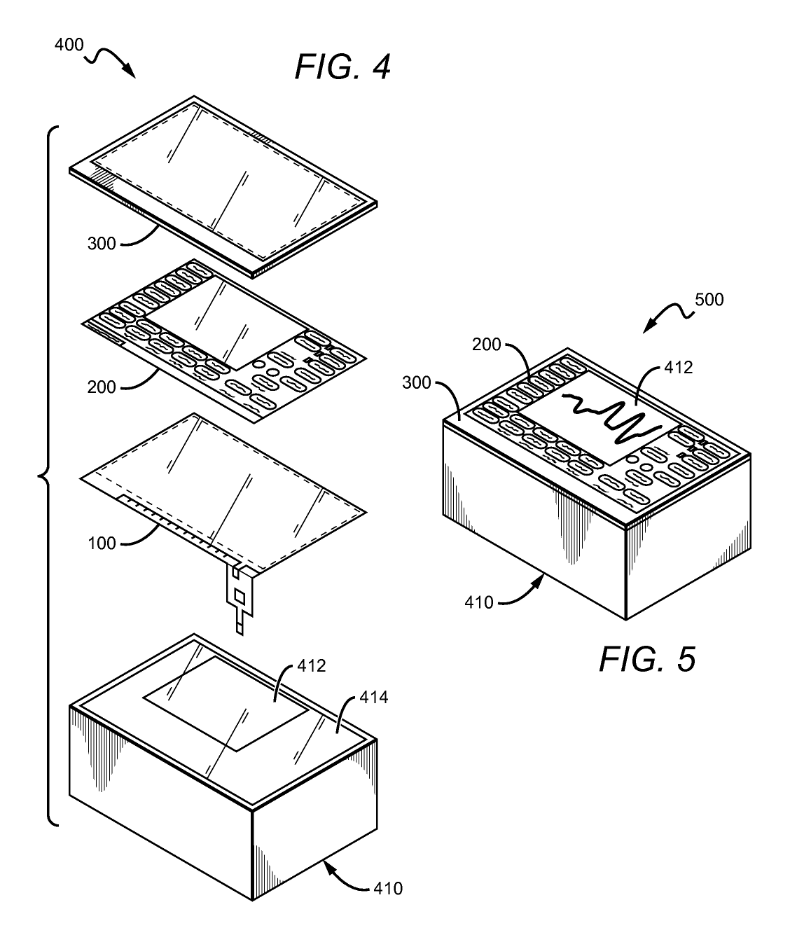

In FIG. 4, the general configuration of glass cover 300 overlays label 200, which then overlays touch screen 100, which then overlays device 410 with dynamic screen 412 and static light panel 414. Device 410 is shown euphemistically as a device that has a touch screen with both static and dynamic touch screen components, for example medical equipment, automotive equipment, or televisions. When device 410 is activated, dynamic screen 412 is revealed through dynamic touch-sensitive area 220 while static light panel 414 illuminates static touch-sensitive areas 210. Preferably bezel 310 mechanically attaches to device 410 to allow for easy placement and replacement of touch screen 100 or label 200, especially during rapid prototyping. FIG. 5 shows device 410 with all components assembled, where dynamic screen 412 shows a graphical output of a measurement taken by device 410.

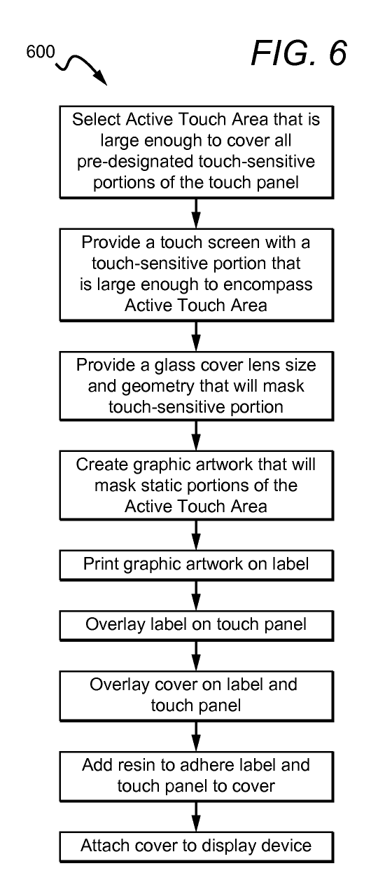

The general method for designing and constructing a touch panel display is shown in FIG. 6. A user will generally design a device with a pre-designated touch-sensitive portion, or an Active Touch Area, that may have both dynamic and static touch-sensitive portions. While the dynamic touch-sensitive portions generally require both a dynamic screen to display dynamic data and a touch-sensitive screen to record tactile input, the static touch-sensitive portions could be produced with just a touch-sensitive screen and a static label.

The user would then create a touch screen with a touch-sensitive portion that is large enough to encompass the envisioned Active Touch Area and a glass cover lens that will mask the touch-sensitive portion and protect the delicate touch screen below the glass. Once these area constraints are known and provided, the user could then use a graphic program to label static portions of the Active Touch Area to create a label. The label could have die cut windows or transparent thermoplastic that allow the dynamic screen to be viewed from the front of the label.

Once the label is properly designed, the label could be printed and overlayed on a touch panel, which is then placed in between a cover and the display device. If the label has been printed in error, the user could then remove the cover and reprint the label until the right look and feel is obtained, at which point the user could then add resin to adhere the label and touch panel to the cover, and then attach the cover to the display device.

Thus, specific compositions and methods of providing touch panel graphics have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A touch panel, comprising:
a touch screen having a touch-sensitive side;
a transparent cover that at least partially masks the touch-sensitive side; and
a label sandwiched between the touch-sensitive side and the cover.

2. The touch panel of claim 1, wherein the touch-sensitive side comprises a capacitive touch screen.

3. The touch panel of claim 1, wherein the touch-sensitive side comprises an indium tin oxide projected screen.

4. The touch panel of claim 1, wherein the touch-sensitive side comprises a resistive touch screen.

5. The touch panel of claim 1, wherein the cover fully masks the touch-sensitive side.

6. The touch panel of claim 1, wherein the cover is less than 10 mm thick.

7. The touch panel of claim 1, wherein the cover is less than 4 mm thick.

8. The touch panel of claim 1, wherein the cover is less than 2 mm thick.

9. The touch panel of claim 1, wherein the cover comprises a magnification lens.

10. The touch panel of claim 1, wherein the cover comprises a bezel.

11. The touch panel of claim 1, wherein the label comprises a transparent adhesive that bonds the label to at least one of the cover and the screen.

12. The touch panel of claim 1, wherein the label comprises a thermoplastic.

13. The touch panel of claim 1, wherein the label comprises a hole.

14. A method of labeling a surface of a touch screen, comprising:
designating a portion of the surface to receive tactile input;
providing a transparent cover that masks the designated portion of the surface;
providing a label that at least partially masks the designated portion of the surface; and
layering the label and the transparent cover over the designated portion to allow the designated portion of the surface to receive tactile input.

15. The method of claim 14, wherein the touch screen comprises a capacitive touch screen.

16. The method of claim 14, further comprising tinting the cover to give the cover a translucent quality.

17. The method of claim 14, further comprising illuminating the label.

18. The method of claim 14, further comprising creating an air-tight seal between the cover and the touch screen.
